(19) United States
(12) Patent Application Publication
(10) Pub. No.: US 2003/0006237 A1
(43) Pub. Date: Jan. 9, 2003

(54) Side opening trash container

(76) Inventors: Vito Passantino, Bartlett, IL (US); Tinamarie Passantino, Bartlett, IL (US)

Correspondence Address: Law Offices of John D. Gugliotta, 137 South Main Street, Suite 202, Akron, OH, 44308, US

(21) Appl. No.: 09/879,021

(22) Filed: Jun. 13, 2001

(51) Int. Cl. B65D 25/14; B65D 35/14; B65D 90/00; B65F 1/00

(52) U.S. Cl. 220/495.06; 220/908

(57) ABSTRACT

A trash container that allows for the removal of filled trash container liners without the lifting of the said liners is provided consisting of a trash container equipped with a hinge system and associated latch that allows for the opening of at least one vertical surface.

### BACKGROUND OF THE INVENTION

1. Field of the Invention

The present invention relates generally to trash containers and, more particularly, to a side opening trash container.

2. Description of the Related Art

In the related art, numerous attempts have been made to improve the utilization of trash containers with regards to ease of use when used with trash container liners. These improvements have ranged from simple containers with vacuum release tubes to complex lifting apparatuses which utilize mechanical mechanisms to raise the filled liner from the trash container and the like. A search of the prior art did not disclose any patents that read directly on the claims of the instant invention; however, the following references were considered related:

| U.S. Pat. No. | Inventor | Issue Date |
|---|---|---|
| 4,630,752 | DeMars | Dec. 23, 1986 |
| 4,955,497 | Winden et al. | Sep. 11, 1990 |
| 4,923,080 | Lounsbury | May 8, 1990 |

The previous art consists of several devices in which the usability of trash containers when used with trash container liners is increased. These devices, however, have one or more of the following problems.

First, the devices can be complex, and therefore, expensive to manufacture. The public is less likely to purchase an expensive side opening trash container.

Second, many of the previous devices utilize small parts, openings, crevices, and other such features which do not allow for the user to keep said invention clean and in a state of general sanitization. The ability to keep a trash container in a clean state is important to the general health of those exposed to the said trash container.

Third, some of the above devices improve the general utilization of trash containers when not used with associated trash container liners and are thus not suited for specific use with trash container liners.

Fourth, several of the previous devices are designed to hold a plurality of trash bags and are thus not suitable for use with a single trash bag.

Fifth, many of the previous devices utilize complex mechanisms to raise the filled trash container liner and thus operation is not obvious to the untrained user.

Sixth, many of the previous devices address the problems of using a trash container in a public place and are thus not suitable for the challenges faced by a trash container in a residential or other non-public location.

Seventh, some of the previous devices are asymmetrical in nature about their vertical axis and thus require an inordinate amount of floor space to accomplish their objective.

Eighth, some of the previous devices are for the automated lifting of trash receptacles by mechanical collection means and are thus not suitable for use when trash collecting duties are performed by humans.

Ninth, some of these devices are so complex in design with numerous moving component parts. This increases the likelihood of mechanical failure of the component parts, resulting in numerous and expensive repairs that are cost prohibitive.

Consequently, a need has therefore been felt for an improved but less complex mechanism that allows for a side opening trash container.

### SUMMARY OF THE INVENTION

It is therefore an object of the present invention to provide an improved trash container.

It is therefore another object of the present invention to provide for an improved trash container that allows for the removal of a filled trash container liner without requiring lifting of said filled trash container liner.

It is yet another object of the present invention to provide for an improved trash container that can be manufactured in varying sizes and shapes.

It is still yet another object of the present invention to provide for an improved trash container that is easily cleaned and sanitized to allow for healthier living conditions.

Briefly described according to the preferred embodiment of the present invention, the invention comprises a trash container for use with trash container liners. The trash container is equipped with a hinge system and associated latch that allows for the opening of at least one vertical surface. When weight lifting limitations or other physical ailments prevent a user from lifting the filled trash container liner from the trash container, the latch is released and the filled trash container liner is removed via a horizontal sliding motion. When opened, the side opening trash container may easily be cleaned and/or sanitized to provide for healthier living conditions.

An advantage of the present invention is that its operation is intuitively obvious to the user with little or no training required.

Another advantage of the present invention is that it facilitates the removal of filled trash container liners when conditions, such as vacuum, prevent or hinder their removal from conventional trash container containers.

Another advantage of the present invention is that it is simple, and therefore, inexpensive to manufacture. This savings, if passed on to the consumer, may influence the public to utilize such a device. A simple design also increases product reliability and useful product lifetime.

Another advantage of the present invention is that it provides independence to users who are unable to lift heavy weights or are afflicted by physical disabilities.

Another advantage of the present invention is that it is easily produced from readily available materials using known manufacturing techniques, thus allowing for an economical and practical product.

### BRIEF DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 is a perspective view of the side opening trash container shown in closed state with a trash container liner installed according to the preferred embodiment of the present invention;

FIG. 2 is a side view of the side opening trash container;

FIG. 3 is a top view of the side opening trash container; and

FIG. 4 is a perspective view of the side opening trash container shown in a partially open state with a filled trash container liner.

FIG. 5 is a perspective view of an alternate embodiment of the present invention in the closed position.

### DESCRIPTION OF THE PREFERRED EMBODIMENTS

The best mode for carrying out the invention is presented in terms of its preferred embodiment, herein depicted within the Figures.

### 1. Detailed Description of the Figures

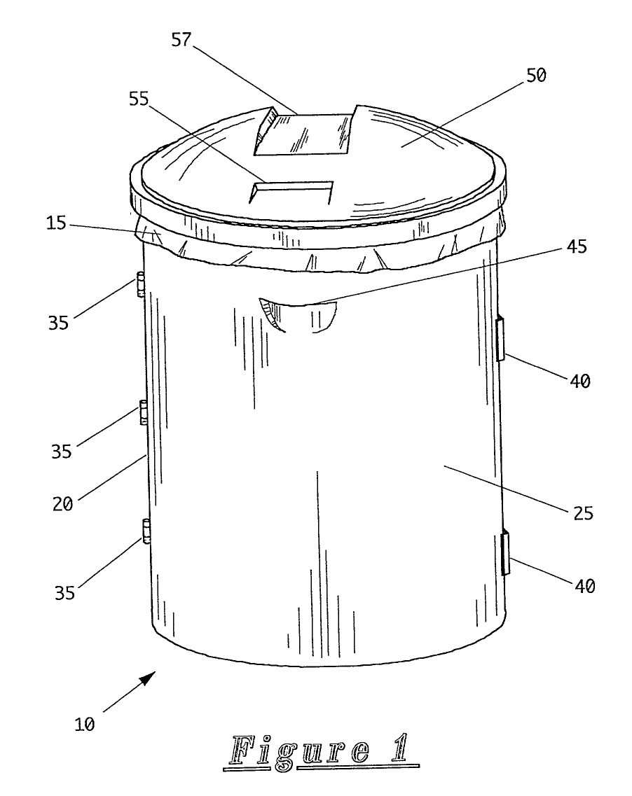

Referring now to FIG. 1, a perspective view of a side opening trash container 10 is shown in closed state with a trash container liner 15 installed according to the preferred embodiment of the present invention. A container 20 is formed by an opening segment 25 and a stationary segment 30 (not shown in this FIG. for illustrative purposes). They are connected along one of their common sides by at least three hinges 35, all of which lie flush against the exterior surface of the opening segment 25 and the stationary segment 30. The opening segment 25 and the stationary segment 30 are secured via at least one latch 40. The preferred embodiment shows two latches 40. A pair of access hand grooves 45 (only one shown for illustrative clarity) is provided on both the opening segment 25 and the stationary segment 30, and are positioned in such a manner as to aid the user in carrying the side opening trash container 10 or for separation of the opening segment 25 from the stationary segment 30 as will be described in greater detail below. The access hand grooves 45 are of the handle type configuration and are formed as indentations in the respective opening segment 25 and stationary segment 30. A trash container lid 50 is provided to contain the trash within the side opening trash container 10 and to provide protection for the user against unpleasant olfactory and visual intrusions during use. A pair of trash container lid access hand grooves 55 is provided as an integral part of the trash container lid 50 to aid the user in placement and removal of the trash container lid 50 upon the container 20 in much the same manner as conventional residential trash containers.

A trash container lid flap 57 is positioned inside of the trash container lid 50, and is hinged in its middle such that trash container lid flap 57 swings freely along its horizontal axis. The trash container lid flap 57 thus facilitates the quick and easy filling of the trash container liner 15 with refuse.

The shape of the side opening trash container 10 as shown in this FIG. is indicated as a circular cross section unit in its vertical plane. It should be noted however that other functional forms such as rectangular and square could also be utilized and should not be interpreted as a limiting factor. It is envisioned that the side opening trash container 10 would be manufactured using plastic or galvanized steel in much the same manner as conventional trash containers for residential use using such manufacturing procedures as injection molding, stamping, rolling and/or welding.

Referring next to FIG. 2, a side view of the container 20 is disclosed. A reinforcing rim 60 is provided on the upper portion of the opening segment 25 and the stationary segment 30 (not shown in this FIG. for illustrative clarity) to provide structural integrity to the container 20 and to provide a gripping surface for the trash container liner 15 (not shown in this FIG.) when installed. The hinges 35 are envisioned to be manufactured from the same material as the container 20, namely plastic or steel and will provide at least a 270° swing radius for the opening segment 25 to swing through. Additionally, the latches 40 and the access hand grooves 45 would be manufactured from the same respective material as the container 20. In the case of plastic materials, it is envisioned that the hinges 35, the latches 40 and the access hand grooves 45 would be formed as an integral part of the opening segment 25 and the stationary segment 30 (not shown in this FIG. for illustrative clarity).

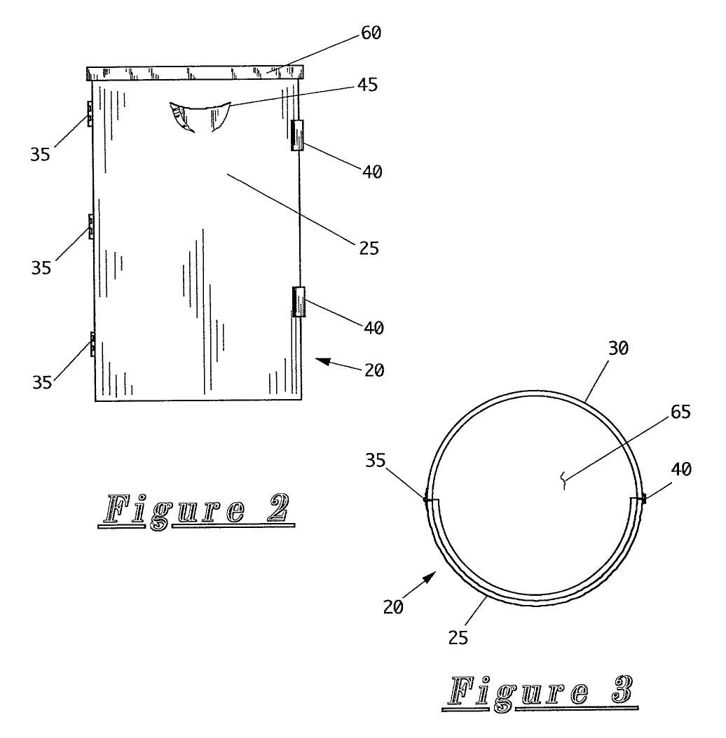

Referring now to FIG. 3, a top view of the container 20, as looking down into its opening is depicted. A bottom surface 65 is disclosed to provide a surface upon which the trash container liner 15 (not shown for illustrative clarity) to rest when in a utilized state. The bottom surface 65 is connected to the stationary segment 30 along one segment of its adjacent perimeter as shown. The other segment of its perimeter is thus adjacent to opening segment 25 though not connected. The access hand grooves 45 provide a means by which the user container supply equal but opposite force to allow for the opening of the opening segment 25 from the stationary segment 30 when the latches 40 are released and swung about the axis as defined by the hinges 35. The opening thus defined when the hinges 35 are in their fullest open position is therefore equal to the diameter as defined by the trash container liner 15 (not shown in this FIG.) and would thus allow for its subsequent removal. It can be seen that if the container 20 were to take the shape of a rectangular or square unit, the opening segment 25 would only be required to take the length of one of the widest sides as the trash container liner 15 (not shown in this FIG.) would assume.

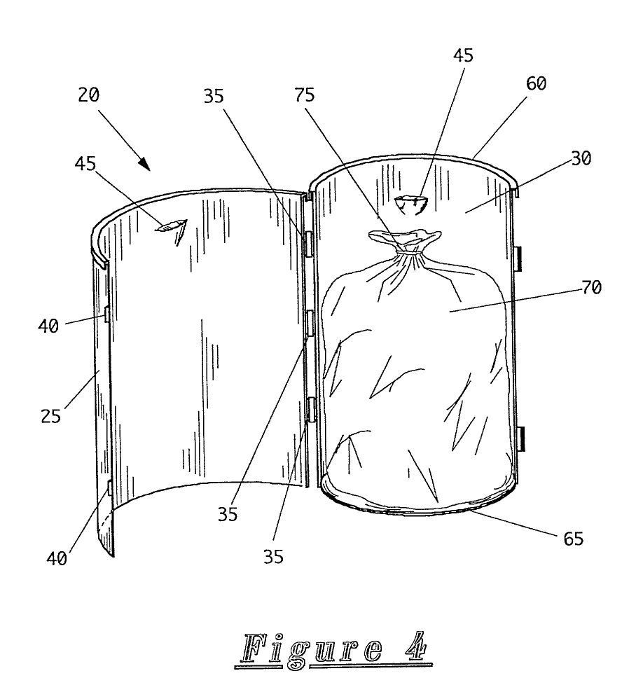

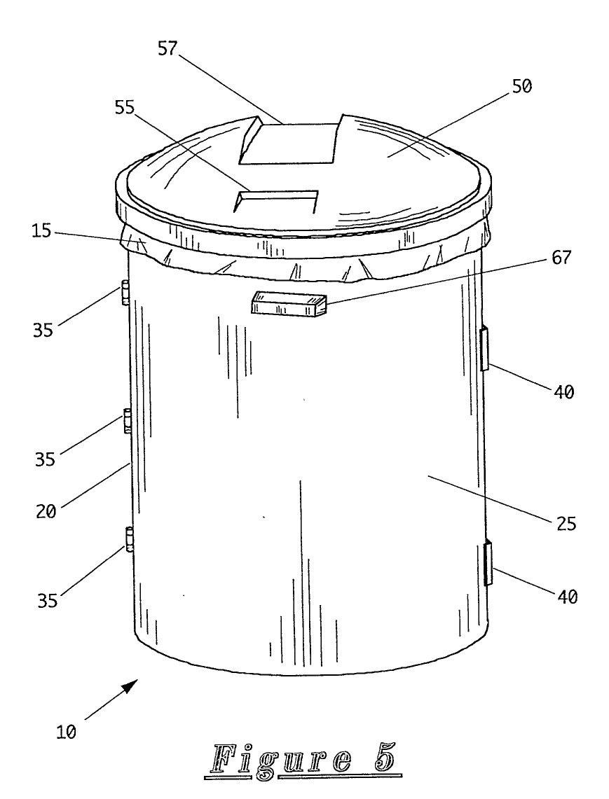

Referring finally to FIG. 4, a perspective view of the side opening trash container 10 shown in a partially open state with a filled trash container liner 70 is disclosed. The filled trash container liner 70 would be closed by the user and secured via a closure means 75 such as a metal reinforced twist-tie or plastic locking strip in an ordinary manner as found with conventional trash container liners. The user would then open the container 20, as aforementioned described by utilization of the hinges 35, the latch 40, and the access hand grooves 45 to allow the opening segment 25 to open with respect to the stationary segment 30. This action would then provide access to the filled trash container liner 70. The filled trash container liner 70 is then slid from its resting place atop the bottom surface 65 and disposed of in accordance with applicable regulations. This said sliding action does not require the user to lift the filled trash container liner 70 above the level of the reinforcing rim 60 as would be found with conventional trash containers. The lack of the lifting requirement allows users with weight lifting limitations or other physical disabilities to utilize the side opening trash container 10 (not shown in this FIG.) as compared to conventional trash containers. The side opening feature would also be enjoyed by users who do not have a weight lifting limitation or other physical disability but who do endure aggravation when trying to remove a filled trash container liner 70 from a conventional trash container and vacuum pressure prevents them from doing so. Such aggravation is most apparent when light weight refuse that assumes the shape of the conventional trash container such as daily refuse, forms a tight vacuum seal. While the container 20 is in its open state as shown, conditions are facilitated to allow the user to wipe out, clean and/or sanitize the container 20. This said wiping, cleaning and/or sanitizing action is much more convenient as compared to conventional trash containers, thus encouraging the user to perform said actions. These actions promote a healthier living environment around the container 20.

Referring now to FIG. 5, an alternate embodiment of the present invention is shown wherein the access hand grooves 45 are replaced by traditional access handles 67.

### 2. Operation of the Preferred Embodiment

In operation, the present invention can be easily utilized by the common user in a simple and effortless manner. To use the present invention with its preferred embodiment can best be described in conjunction with the perspective views of FIG. 1 and FIG. 4, the side view of FIG. 2, and the top view of FIG. 3.

The user would begin utilization of the side opening trash container 10 by installing the trash container liner 15 into the container 20 and securing the opening of the trash container liner 15 around the reinforcing rim 60 as would be found with a conventional trash container. The trash container lid 50 is then put in place. Refuse is then placed inside the trash container liner 15 via the trash container lid flap 57. Refuse is continually added to the trash container liner 15 until the trash container liner 15 is filled. At this point the user is ready to remove the filled trash container liner 70.

To remove the filled trash container liner 70 the user would first remove the trash container lid 50 by using the trash container lid access hand grooves 55, then release the outer edges of the filled trash container liner 70 from the reinforcing rim 60 and secure all open edges of the filled trash container liner 70 with a closure means 75. Next, the user would release the latch 40, and grasp the access hand grooves 45. With a swinging action, the opening segment 25 is swung away from the stationary segment 30, as defined by the swing radius of the hinges 35, thus exposing the filled trash container liner 70 resting upon the bottom surface 65. The user would then simply grasp the filled trash container liner 70 about the closure means 75 and slide it away from the container 20. The filled trash container liner 70 would then be disposed of in accordance with any applicable regulations as in a conventional manner. At this point, the user is ready to clean and/or sanitize the side opening trash container 10 if desired.

To clean and/or sanitize the side opening trash container 10, the user would leave the container 20 in its open state as previously defined. The cleaning process could range from a simple wiping out with a cloth, to a fully involved process utilizing water, cleaning chemicals, and/or pressure washers. To sanitize the side opening trash container 10 if so desired, the user would apply a sanitizing chemical and/or disinfectant to all surfaces of the side opening trash container 10. At this point the user would be ready to reinstall an empty trash container liner 15 and the process would repeat as above described.

The foregoing description is included to illustrate the operation of the preferred embodiment and is not meant to limit the scope of the invention. The scope of the invention is to be limited only by the following claims.

What is claimed is:

1. A trash container comprising:
an opening container segment having an interior surface and an exterior surface and having a vertical, linear side;
hinge means lying flush against said exterior surface of said opening segment;
a stationary container segment, said stationary container segment connected along one side to one side of said opening container segment at said hinge means; and
at least one latch for securing said opening segment to said stationary segment;
and wherein said opening segment is pivotally affixed about said edge of said stationary segment in a manner such that said opening segment and said stationary segment are capable of affixment in a manner such as to form a volume that can function as an otherwise conventional trash container.

2. The trash container of claim 1, further comprising:
a first access hand groove formed concavely within said opening segment; and
a second access hand groove formed concavely within said stationary segment;
and wherein said pair of access hand grooves are positioned in such a manner as alternately to aid the user in carrying said side opening trash container and to separate said opening segment from the stationary segment.

3. The trash container of claim 2, wherein said access hand grooves are of the handle type configuration and are formed as indentations in the respective opening segment and stationary segment.

4. The trash container of claim 1, further comprising:
a trash container lid, said lid for fittingly seating upon said side opening trash container when said side opening trash container is in a closed configuration, said lid including a pair of trash container lid access hand grooves an integral part of said trash container lid in to aid the user in placement and removal of the trash container lid upon said container.

5. The trash container of claim 3, further comprising:
a trash container lid flap, said flap positioned inside of said trash container lid and hinged at said lid's middle such that said trash container lid flap swings freely along its horizontal axis;
and wherein said trash container lid flap thereby facilitates the quick and easy filling of the trash container liner with refuse.

6. The trash container of claim 1, wherein the shape of said side opening trash container when in a closed configuration has a circular cross section in its vertical plane.

7. The trash container of claim 1, wherein said opening container segment and said stationary container segment are manufactured from one of a group of materials comprising plastic and galvanized steel.

8. The trash container of claim 1, further comprising:
a first reinforcing rim provided on the upper portion of said opening segment; and
a second reinforcing rim provided on the upper portion of said stationary segment;
and wherein each said reinforcement rim functions to provide structural integrity to the container as well as to provide a gripping surface for a trash container liner of a type generally in use.

9. The trash container of claim 1, wherein said provide at least a 270° swing radius for the opening segment relative to said stationary container segment.

10. The trash container of claim 1, wherein said stationary container segment further comprises a container bottom surface to provide a surface upon which trash or a trash container liner 15 will rest when in a utilized state, said bottom surface connected to the stationary segment along one segment of its adjacent perimeter.
